(19) United States
(12) Patent Application Publication
(10) Pub. No.: US 2026/0109102 A1
(43) Pub. Date: Apr. 23, 2026

(54) SYSTEM AND METHOD FOR MANUFACTURING GRADIENT MATERIAL STRUCTURES, SUCH AS GRADIENT REFRACTIVE INDEX MATERIALS

(71) Applicants: Deepak Langhe, Katy, TX (US); Thomas D. Lopez, Tomball, TX (US)

(72) Inventors: Deepak Langhe, Katy, TX (US); Thomas D. Lopez, Tomball, TX (US)

(21) Appl. No.: 19/147,707

(22) PCT Filed: Jan. 27, 2024
(86) PCT No.: PCT/US2024/013267

§ 371 Date: Jul. 13, 2025

Related U.S. Application Data
(60) Provisional application No. 63/441,736, filed on Jan. 27, 2023.

(51) Int. Cl. B29C 48/495; B29C 48/70; B29C 48/71; B29D 11/00

(52) U.S. Cl. CPC B29C 48/495; B29C 48/705; B29C 48/71; B29D 11/00355

(57) ABSTRACT

A system for manufacturing a gradient material structure comprises a proportioner feedblock section and a mixer feedblock section. The proportioner feedblock section has a first flow inlet for receiving a first polymer material in melted form, a second flow inlet for receiving a second polymer material in melted form, and one or more proportioner channels. Each mixer channel may 2024/159199 be configured to simultaneously receive from the corresponding proportioner channel the first polymer material at a first volume flow rate and the second polymer material at a second volume flow rate. Bic ratio between the first and second volume flow rates may be defined by a polymer transfer ratio for the respective mixer channel. The polymer transfer ratios may differ between two or more of the mixer channels. Each proportioner channel may be housed within a respective insert cassette removably mounted within the remainder of the proportioner feedblock section.

### RELATED APPLICATIONS

This application claims the benefit of U.S. Provisional Application No. 63/441,736 filed Jan. 27, 2023, the content of which is incorporated by this reference in its entirety for all purposes as if fully set forth herein.

### TECHNICAL FIELD

The present disclosure relates generally to the field of manufacturing gradient materials, such as gradient refractive index materials and associated products.

### BACKGROUND

Feedblock technologies in extrusion or co-extrusion of polymer materials exist in the conventional art as methods for creating structures. These technologies have been around for 50+ years and allow coextrusion of one or more polymers through channels. These technologies are used for coextrusion of layered materials for packaging or optical applications.

In conventional gradient optics technology, nanolayered film technology is used in developing polymer gradient index elements. For example, two polymers are extruded to create films of 1000s of layers with individual layer thickness below the quarter wavelength of light such that the combination of two materials create a plastic film with a constant refractive index, dependent on the ratio of two polymers mixed. A family of nanolayer film rolls is created followed by the stacking and consolidation in the next step to create gradient index elements.

In conventional 3D-printed gradient refractive index (GRIN) fabrication technology, a layer with different refractive index material is printed to create a final GRIN element.

### SUMMARY

The present disclosure teaches a system and method for manufacturing using a composite feedblock which mixes polymer materials in varying concentration and combine to create polymer products with gradient profile. The present disclosure also teaches a methodology using feedblock technology to create graded/gradient refractive index sheets for gradient index lens fabrication. The proposed feedblock methodology utilizes at least two polymers and combines in a multi-channel feedblock. Mixing of polymers in different channels created a layer reduction technology to create gradient mixing of polymers.

Applications of gradient refractive index optics materials are disclosed herein. The channels in the feedblock are preferably designed to control the relative throughput of the component polymers in consecutive channels and combined in a new feedblock or a new section of the feedblock to create a mixture of two or more polymers within the channel. Two or more consecutive channels combine to create an additive mixture of the two polymers with refractive index different than the individual components. In particular embodiments of the system and method, each polymer mixture stream output will have different refractive index material which combine to create a gradient sheet profile. Each polymer stream can be individual polymers, blends of polymers, or may contain other additives or fillers.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic top view of a first example system for manufacturing a gradient material structure, in accordance with the present disclosure;

FIG. 2 is a diagrammatic cross-sectional view taken along lines 2-2 in FIG. 1;

FIG. 3 is a diagrammatic cross-sectional view similar to the cross-section of FIG. 2, but wherein the feedblock sections are shown unfastened and disassembled from one another;

FIG. 4 is a diagrammatic front view of the proportioner feedblock section of the system shown in FIG. 1;

FIG. 5 is a diagrammatic front view of an alternate example of a proportioner feedblock section;

FIG. 6 is a diagrammatic top view of an alternate example system for manufacturing a gradient material structure, wherein the system implements an auxiliary polymer material in addition to a first and second polymer material;

FIG. 7 is a diagrammatic front view of one example proportioner feedblock section which may be used in the system shown in FIG. 6;

FIG. 8 is a diagrammatic front view of another example proportioner feedblock section which may be used in the system shown in FIG. 6;

FIG. 9 is a diagrammatic perspective view of an example system for manufacturing a gradient material structure, this example system including a combiner feedblock section following the mixing feedblock section;

FIG. 10 is a diagrammatic perspective view of an example system for manufacturing a gradient material structure, wherein the combiner feedblock section is removed to show the mix outlets of the mix channels;

FIG. 11 is a diagrammatic view illustrating the optional selection of feedblock sections which may be implemented in a system of the present disclosure;

FIG. 12 is a diagrammatic perspective view of yet another example of a proportioner feedblock section, wherein each proportioner channel is housed within a respective insert element removably mounted within the remainder of the proportioner feedblock section;

FIG. 13 is a diagrammatic perspective view of another example of a proportioner feedblock section, wherein multiple proportioner channels are defined in a single insert element removably mounted within the remainder of the proportioner feedblock section;

FIG. 14 is a diagrammatic view illustrating the translation of polymer material streams from proportioner channels of an example proportioner feedblock section (which may otherwise be referred to herein as “section A”) to the corresponding mix channels of the mixer feedblock section (which may otherwise be referred to herein as “section B”), wherein the alternating proportioner channels feed two polymer components;

FIG. 15 is a diagrammatic view illustrating a mixing zone within an example mix channel for improving melt stream mixing;

FIG. 16 is a diagrammatic perspective view of one example manufacturing system in accordance with the present disclosure, wherein the proportioner feedblock section is shown disassembled from the corresponding mixer feedblock section, illustrating how in certain embodiments of the system some or all of the mixer channels may be in fluid communication with the proportioner outlet of the same proportioner channel;

FIG. 17 is a diagrammatic view illustrating cross-sections of the two polymer materials as they are extruded from the proportion channel to the corresponding mixer channels, and finally extruded from the combiner channel to result in the formed gradient structure;

FIG. 18 is a diagrammatic exploded view of one alternate example of a proportioner feedblock section;

FIG. 19 is a diagrammatic perspective view of the example proportioner feedblock section of FIG. 18, but shown in assembled form;

FIG. 20 is a diagrammatic front view of the example proportioner feedblock section of FIG. 19;

FIG. 21 is a diagrammatic perspective view of an alternate example manufacturing system in accordance with the present disclosure, wherein the proportioner feedblock section is of the type shown in FIGS. 18-20 and the feedblock sections are shown disassembled from one another;

FIG. 22 is a diagrammatic perspective view of another example manufacturing system in accordance with the present disclosure, wherein the proportioner feedblock sections are shown disassembled from one another to reveal the configuration and alignment of the proportioner channels in relation to the corresponding mixer channels;

FIG. 23 illustrates one example of a two-polymer stream gradient material structure manufacturing system with different proportioner channel dimensions which combine to create a linear gradient structure by way of a first polymer material and a second polymer material;

FIG. 24 illustrates one example of how additional non-proportioning channels may be implemented on the top and bottom to cap the gradient structure, therefore not requiring any mixer channels corresponding to the non-proportioning channels;

FIG. 25 illustrates one example of how a curved gradient index structure may be manufactured by changing the proportioner channel dimensions;

FIG. 26 illustrates one example of a gradient material structure manufacturing system with the addition of a third polymer stream containing one or more polymers, wherein the third stream may be compatible to be blended with the other polymers within the mixer channels;

FIG. 27 illustrates an alternate example of a gradient material structure manufacturing system with the addition of a third polymer stream containing one or more polymers, wherein the third stream may act as an adhesive layer or a performance enhancer;

FIG. 28 illustrates one example of a gradient material structure manufacturing system in which a linear gradient structure is created with varying proportioner channel dimensions;

FIG. 29 illustrates an alternate example of a gradient material structure manufacturing system in which a non-linear gradient structure is created as a result of variance between the proportioner channels dimensions and corresponding mixer channel dimensions;

FIG. 30 illustrates an example of how one or more additional components, additives, polymers may be added to starting (base) polymer materials implemented in the present gradient materials structure manufacturing system;

FIG. 31 illustrates a variation of consecutive mixing channels with 1% variation with two outside layers without any mixing, wherein the proportioner feedblock section may have 200 proportioner channels and could feed into 101 mixer channels in the mixer feedblock section, and then a combiner feedblock section may combine the separate mixed polymer layers to output a gradient structure;

FIG. 32 is a diagrammatic perspective view of another example manufacturing system in accordance with the present disclosure, wherein feedblock sections are shown disassembled from one another to reveal the configuration and alignment of the proportioner channels in relation to the corresponding mixer channels;

FIG. 33 is a magnified view of the diagram in FIG. 4, for the purpose of showing more detail concerning the geometry and cross-sectional areas of the polymer conduits; and

FIG. 34 is a diagrammatic cross-sectional view of an example polymer die.

### DETAILED DESCRIPTION OF THE PREFERRED EMBODIMENTS

Referring now to the drawings, like reference numerals designate identical or corresponding features throughout the several views.

Various example embodiments of a system for manufacturing a gradient material structure in accordance with the present disclosure are shown generally at 100 in the several drawings presented herewith.

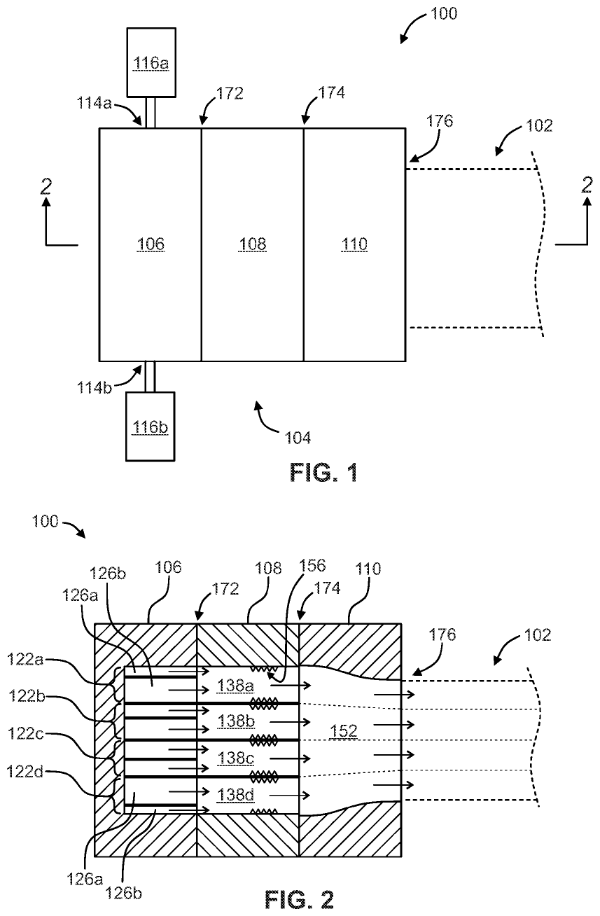

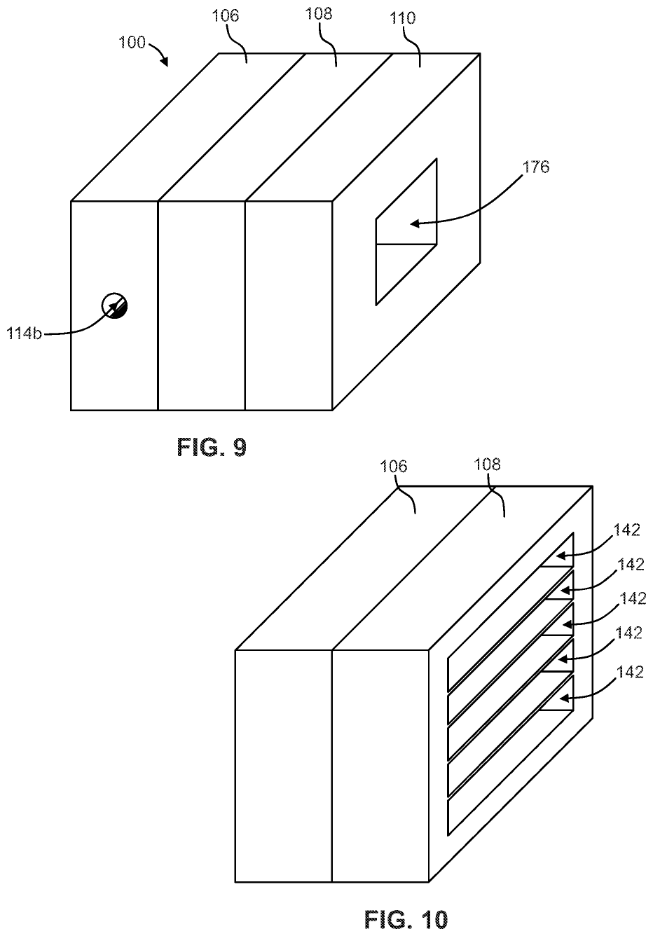

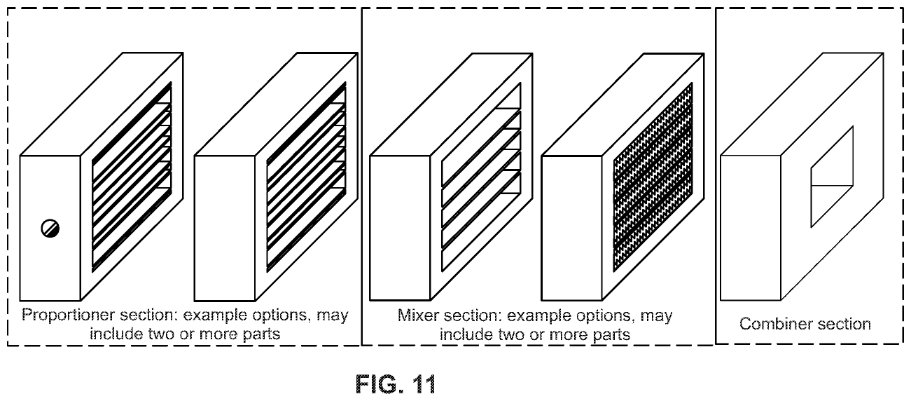

Referring to FIGS. 1, 2 and 9, a system 100 for manufacturing a gradient material structure 102 may comprise a proportioner feedblock section 106 and a mixer feedblock section 108. Certain implementations of the system 100 may further comprise a combiner feedblock section 110. Referring to FIGS. 1-3, the feedblock sections may be separably fastenable to one another to form a composite feedblock 104. Referring to FIGS. 1, 2 and 6, a polymer transfer interface 172 may be defined at the junction between the proportioner feedblock section 106 and the mixer feedblock section 108. Similarly, a mix transfer interface 174 may be defined at the junction between the mixer feedblock 108 and a combiner feedblock 110 or polymer die 112.

Referring to FIGS. 1 and 2, the proportioner feedblock section 106 may have a first flow inlet 114a for receiving a first polymer material in melted form, a second flow inlet 114b for receiving a second polymer material in melted form, and one or more proportioner channels (e.g., 122a, 122b, 122c, 122d). Referring to FIGS. 1-3, in particular preferred implementations of the system 100, each proportioner channel (e.g., 122a, 122b, 122c, 122d) may have a proportioner outlet 124, a first polymer conduit 126a in fluid communication between the first flow inlet 114a and the proportioner outlet 124, and a second polymer conduit 126b in fluid communication between the second flow inlet 114b and the proportioner outlet 124.

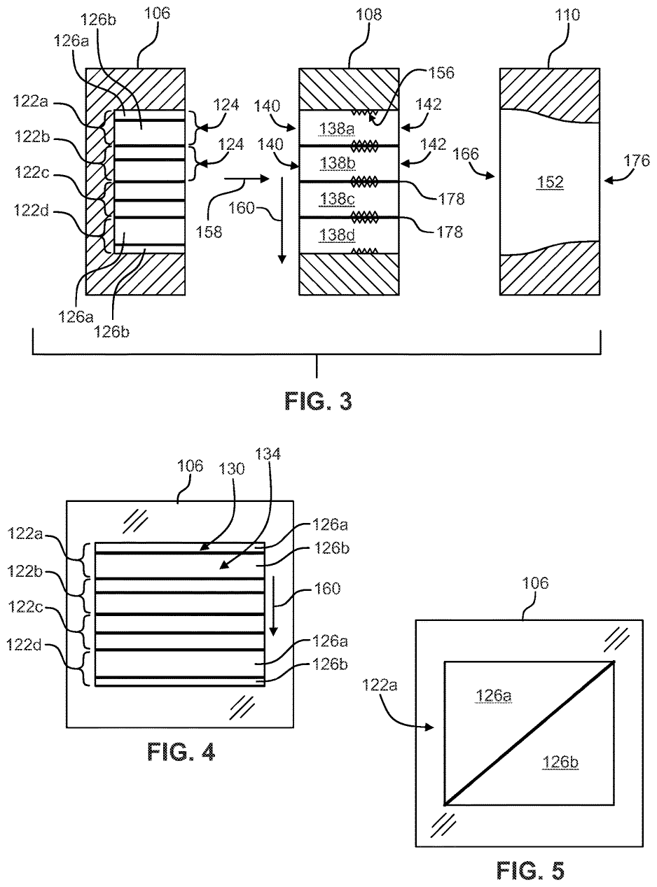

Referring to FIGS. 2 and 3, the mixer feedblock section 108 may have a plurality of mixer channels (e.g., 138a, 138b, 138c, 138d) extending therethrough. Each of the mixer channels may be in fluid communication with the proportioner outlet 124 of a corresponding proportioner channel (e.g., 122a, 122b, 122c, 122d) when the system 100 is in assembled configuration.

In certain preferred implementations of the system 100, each mixer channel (e.g., 138a, 138b, 138c, 138d) may be configured to simultaneously receive from the corresponding proportioner channel (e.g., 122a, 122b, 122c, 122d) the first polymer material 118a at a first volume flow rate and the second polymer material 118b at a second volume flow rate. The ratio between the first and second volume flow rates may define at least in part a polymer transfer ratio for the respective mixer channel. Preferably, the system 100 is configured such that the polymer transfer ratios differ between two or more of the mixer channels.

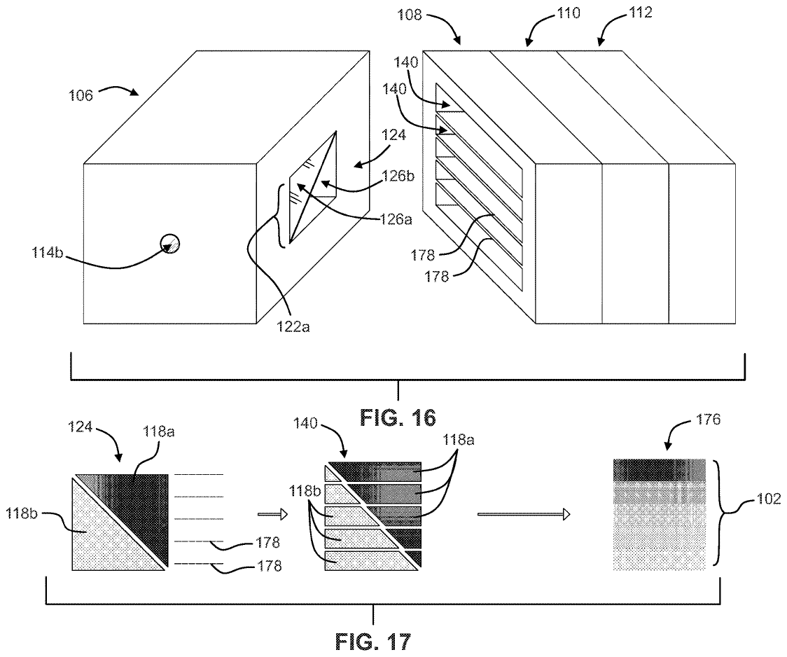

Referring to FIGS. 5, 16 and 17, in particular preferred implementations of the system 100, some or all of the mixer channels (e.g., 138a, 138b, 138c, 138d) may be in fluid communication with the proportioner outlet 124 of the same proportioner channel (e.g., 122a). Moreover, referring to FIGS. 16 and 17, each of the mixer channels may have a mix inlet 140 and a mix outlet 142. In such case, for at least a set of the mixer channels, (i) the mix inlet 140 of each mixer channel may be in alignment in fluid communication with a different portion of the same proportioner outlet 124, and (ii) the polymer transfer ratios may vary between the mixer channels depending upon the alignment of the respective mix inlet with respect to the proportioner outlet 124.

Referring to FIGS. 2 and 3, in certain preferred implementations of the system 100, some or all of the mixer channels (e.g., 138a, 138b, 138c, 138d) may be in fluid communication with proportioner outlets 124 of separate proportioner channels (e.g., 122a, 122b, 122c, 122d).

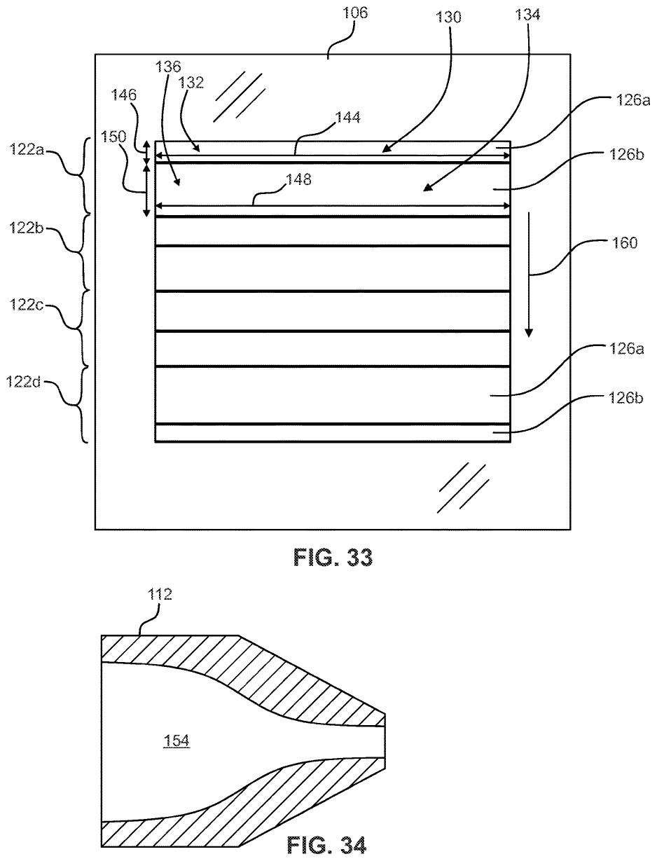

Referring to FIGS. 3, 31 and 33, in particular implementations of the system 100, for each proportioner channel: (a) the first polymer conduit 126a may have, at the proportioner outlet 124, a first cross-sectional geometry 130 with a first cross-sectional area 132, (b) the second polymer conduit 126b has, at the proportioner outlet 124, a second cross-sectional geometry 134 with a second cross-sectional area 136, and (c) the polymer transfer ratio for each mixer channel in fluid communication with the proportioner channel is based at least in part on the ratio of the first and second cross-sectional areas. Moreover, for each proportioner channel, (a) the first cross-sectional geometry 130 may have a first width 144 and a first height 146, (b) the second cross-sectional geometry 134 may have a second width 148 and a second height 150, and (c) the polymer transfer ratio for each mixer channel in fluid communication with the proportioner channel may be based at least in part on the ratio of the first and second heights. In particular such implementations, the first width 144 and the second width 148 may be identical to one another.

Depending up the particular implementations of the system 100, the polymer transfer ratios of the mixer channels may vary between 0.1 to 99.9% (e.g., from one mix inlet 140 to the next mix inlet 140 based on the configuration of the corresponding proportioner channels feeding those mix inlets.). In other implementations of the system 100, the polymer transfer ratios of the mixer channels may vary between 0 to 100%.

Referring to FIGS. 2 and 3, certain preferred implementations of the system 100 may also comprise a combiner feedblock section 110 having at least one combiner channel 152 extending therethrough. Each combiner channel 152 may have a combiner inlet 166 in fluid communication with two or more of the mixer channels (e.g., 138a, 138b, 138c, 138d). Moreover, the combiner feedblock section 110 may have a single combiner channel 152, and the combiner inlet 166 may be in fluid communication with all of the mixer channels when the system 100 is in assembled configuration.

Referring to FIG. 34, particular implementations of the system 100 may comprise a polymer die 112 having a die channel 154 extending therethrough. The die channel 154 may be in fluid communication with each of the mixer channels when the system 100 is in assembled configuration

Referring to FIGS. 2 and 15, in certain implementations of the system 100, at least one of the mixer channels (e.g., 138a) may include surface tortuosity 156 to promote mixing of polymer materials moving therethrough.

In particular preferred implementations of the system 100, the first polymer material 118a may have a first refractive index, the second polymer material 118b may have a second refractive index, and the first and second refractive indexes may be different from one another.

Referring to FIG. 3, in certain implementations of the system 100, the mixer channels (e.g., 138a, 138b, 138c, 138d) may be linearly distributed in a mix channel distribution direction 160. This distribution direction 160 may preferably be orthogonal to the polymer transfer flow direction 158 defined by the direction of movement of the polymer materials entering the mixer channels.

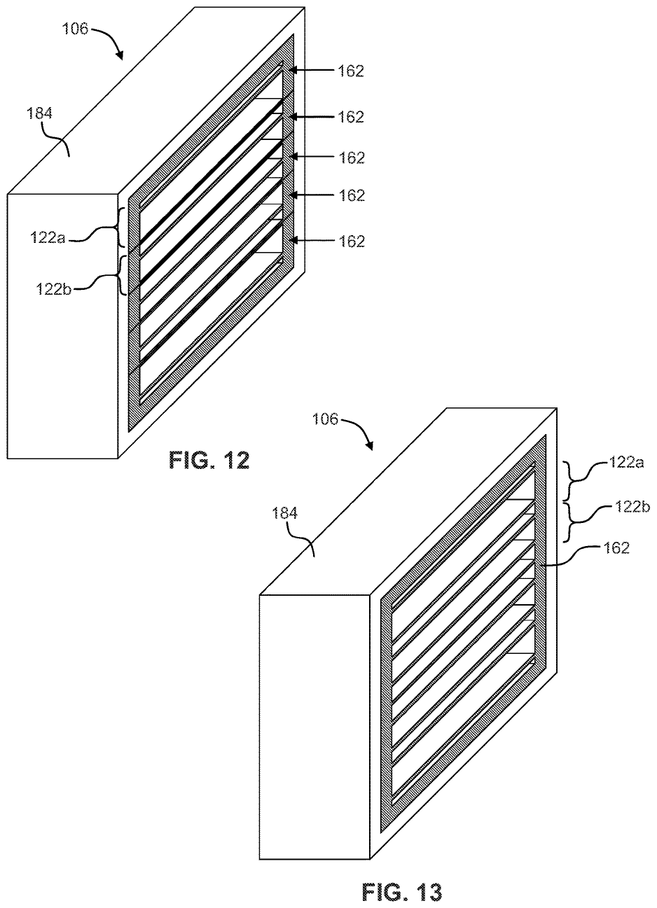

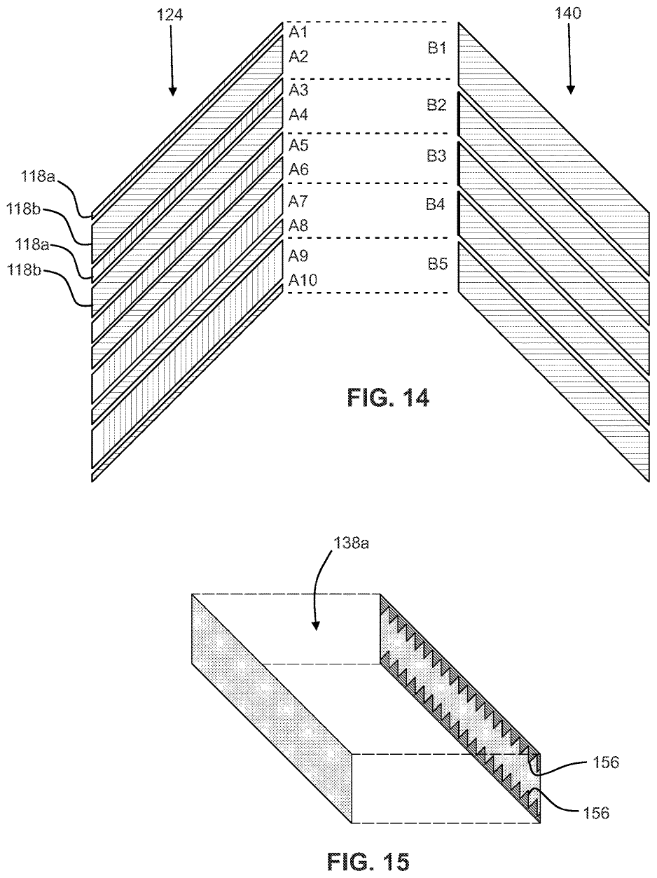

Referring to FIG. 12, in particular implementations of the system 100, each of the proportioner channels (e.g., 122a, 122b, etc.) may be housed within a respective insert element 162 (like a cassette) removably mounted within the remainder of the proportioner feedblock section 106 (e.g., proportioner insert sheath 184). Alternatively, referring to FIG. 13, multiple proportioner channels may be collectively defined (e.g., secured within) in a single insert element 162 removably mounted within the remainder of the proportioner feedblock section 106 (e.g., proportioner insert sheath 184).

Notably, systems 100 in accordance with the present disclosure may include many flow inlets which respectively provide many different varieties of polymer materials into the composite feedblock 104. The flow inlets and the respective polymer conduits are in no way necessarily limited to two. Depending upon the application, the system 100 may be configured to include tens if not hundreds (or more) flow inlets for providing tens, hundreds, or more polymer melts into the system 100.

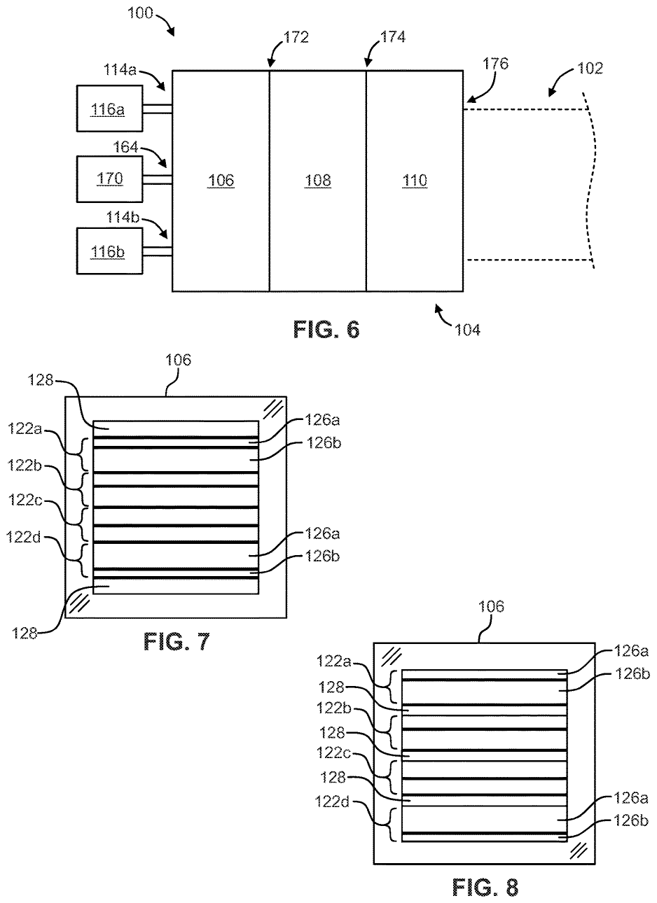

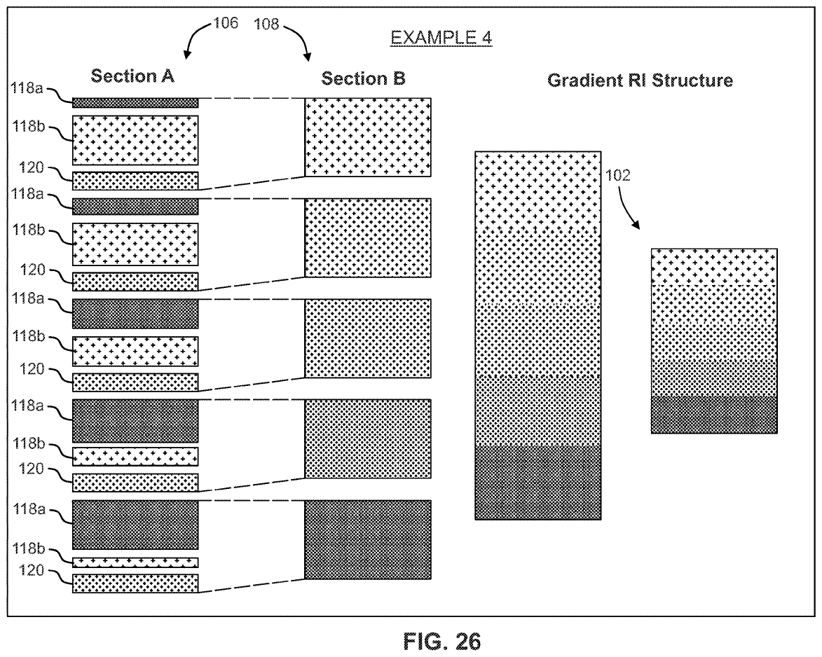

With this in mind, referring to FIGS. 6 and 26, the proportioner section 106 may have an auxiliary flow inlet 164 for receiving an auxiliary polymer material 120 in melted form. At least one proportioner channel may respectively have an auxiliary polymer conduit 128 in fluid communication between the auxiliary flow inlet 164 and the proportioner outlet end. Relatedly, at least one mixer channel may be configured to receive from a corresponding proportioner channel the auxiliary polymer material at an auxiliary volume flow rate, the ratio between the first, second and auxiliary volume flow rates may define at least in part a polymer transfer ratio for the respective mixer channel.

Also notably, the system 100 may be configured to have the mixer feedblock include at least 50 mixer channels. Correspondingly, the proportioner feedblock may include at least 50 proportioner channels. Indeed, the number of channels in each feedblock section may vary from 2 to 4000, but may preferably range from 2 to 250.

At least one of the polymer materials used in the system 100 may comprise chemical constituents able to affect refractive index of the polymer material. Furthermore, referring to FIGS. 6 and 26, the first polymer material 118a may be fed into the first flow inlet 114a by way of a first melt extruder 116a (or the like), the second polymer material 118b may be fed into the second flow inlet 114b by way of a second melt extruder 116a (or the like), and the auxiliary polymer material 120 may be fed into the auxiliary flow inlet 164 by way of an auxiliary melt extruder 170 (or the like).

The present disclosure is intended to address at least two primary topics: (1) a feedblock technology to create gradient materials, and (2) methodology to create gradient index optical elements. The additional disclosure below provides some highlights and additional technical details regarding these topics. Also, while it describes certain potential embodiments of the system and associated features, this disclosure is not intended to be limiting.

### Composite Feedblock to Create Gradient Mixing in Polymer Material Composites

In certain implementations of the system 100, a composite feedblock 104 may include one or more sections ranging from 2 to 100s of channels or conduits with ability to reduce number of channels to allow the mixing of polymer materials followed by combining the mixed materials into a composite structure. The final composite material structure 102 created may be comprised of a controlled mixture of polymers in a layered profile with gradient profile.

In certain implementations of the system 100, a 3-section composite feedblock 104 is demonstrated with possible modification. The first feedblock section A (which may otherwise be referred to herein as a proportioner feedblock section 106), may be configured to be connected to a minimum of one but preferably two extruders or polymer melting systems. The polymer melt streams can split into multiple channels, preferably in alternating fashion into multiple channels or conduits, where the relative size of the conduit cross section can vary as per product design requirement. As the polymer streams enter from first section, A, into the next section of the feedblock B (which may otherwise be referred to herein as a mixer feedblock section 108), the melt streams from consecutive channels can combine together and be mixed to create a blend material.

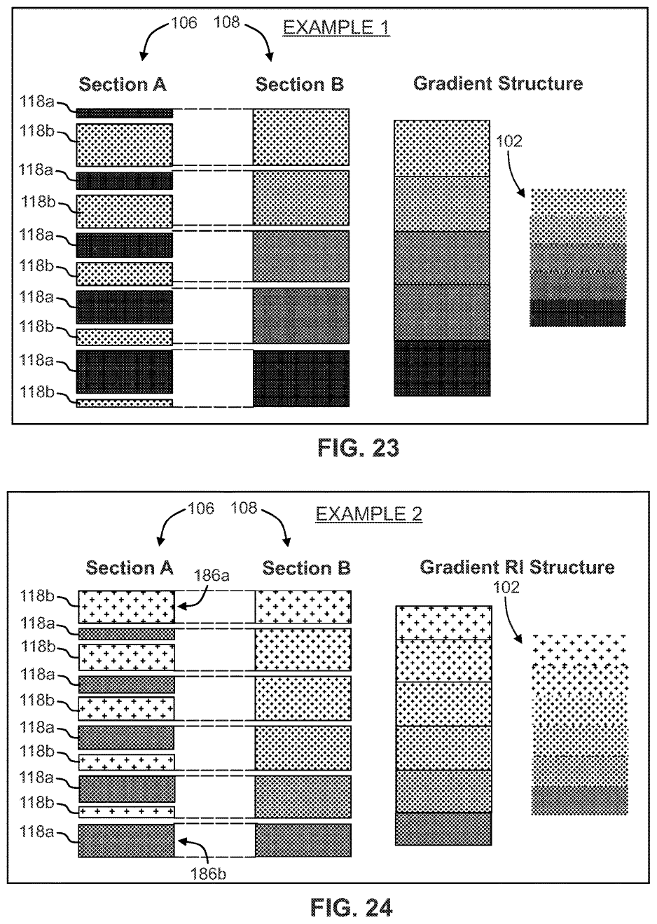

In certain implementations of the system 100, section B of the composite feedblock 104 (which may otherwise be referred to herein as a mixer feedblock section 108) may contain reduced number of channels as the polymer streams are combined to create blend materials. In the example illustrated in FIG. 23, a composite feedblock with 10 channels in section A contains alternating channels of different polymer materials, Polymer A (118a) and Polymer B (118b). Pairs of consecutive melt streams are combined to create five blend mixtures when it enters section B of the composite feedblock. The blending ratio of the two channels will be defined by the material throughput and the channel dimensions. For example, referring to FIG. 14, the two combining channels (channel A1 and channel A2) may have a ratio of cross section 25/75. When the two polymers from these channels combine, a blend material of 25% of Polymer A and 75% of Polymer B will be created in channel 1 (Channel B1) of section B. A schematic shows the relative ratio of Polymer A: Polymer B as 10:90, 25:75, 50:50, 75:25 and 90:10 for the consecutive channels in section A of the feedblock, which is a total of 10 channels, shown as A1, A2, A3, A4, A5, A6, A7, A8, A9, A10. Section B of the feedblock contains five channels (B1, B2, B3, B4, B5) where blend material of Polymer A and Polymer B is created. The 5 channels in section B contain blends with ratio of 10:90, 25:75, 50:50, 75:25 and 90:10. The relative dimensions of channels can vary linearly or non-linearly to create different gradient mixing profiles. The dimensions of the section B channels can also be modified to control the relative ratio of the mixed component.

In certain implementations of the system 100, section A of the composite feedblock 104 may contain an option for additional polymer material. Examples are discussed in further detail below.

In certain implementations of the system 100, the channel dimensions in section B can also be varied to create non-linear gradient mixing structures. Examples are discussed in further detail below.

In certain implementations of the system 100, section A may also contain several hundreds of channels with variation of 1%. Section B channels may contain serrated or mixing promoting elements to improve blending of polymer streams. Examples of structures with different formulation profiles and ability to add additional polymer streams are discussed in further detail below.

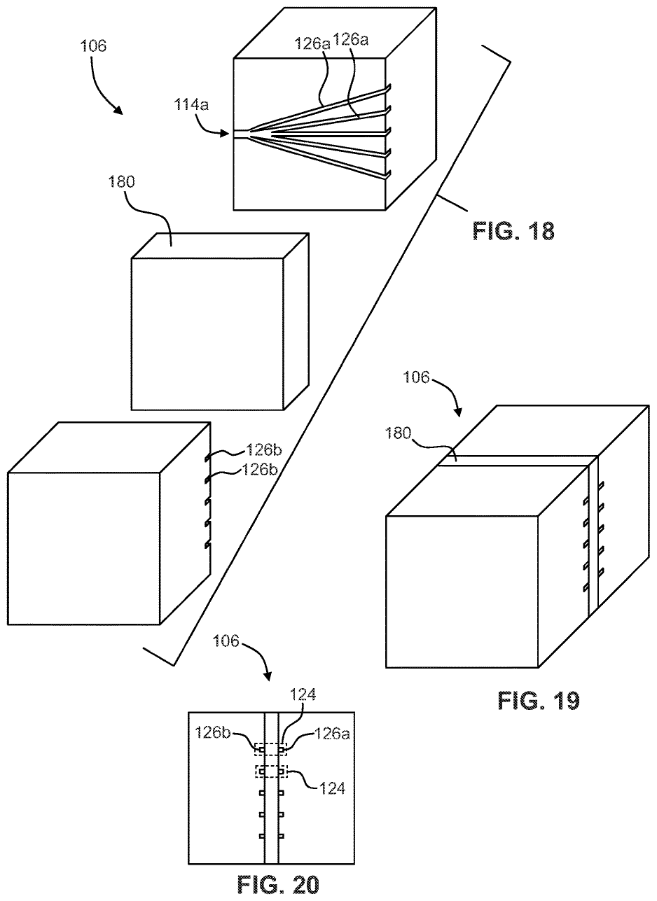

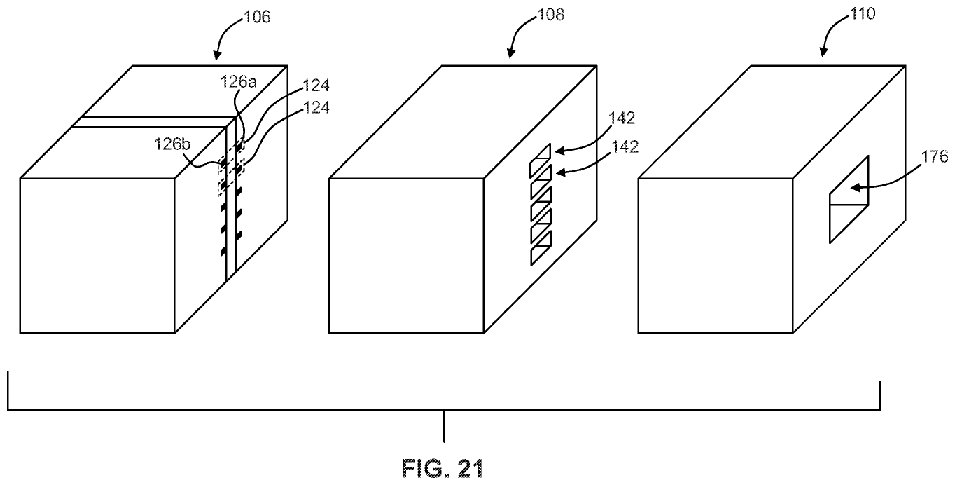

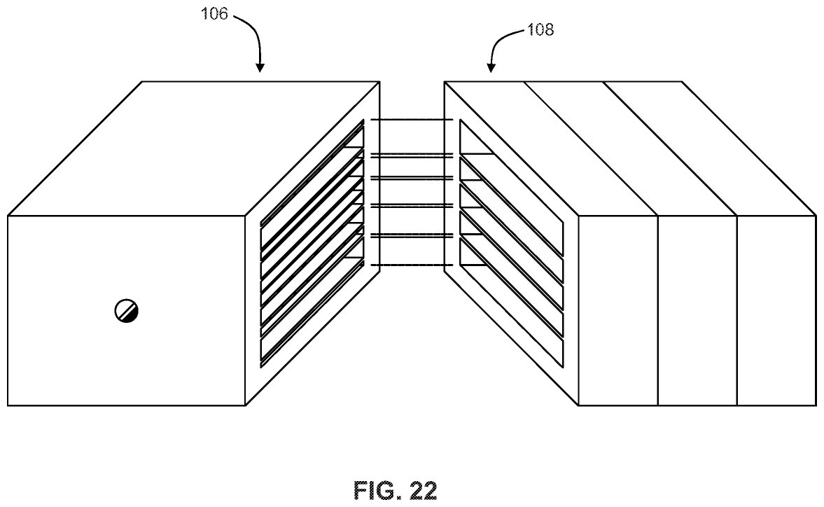

As illustrated for example in FIGS. 18-20, certain implementations of the system 100 may provide an alternative way to create a feedblock, where channels from two polymer streams may be separated by a middle section (e.g., a proportioner feedblock divider 180). The channels from either side of the middle plate may combine to create a mixture of two polymer streams, with the desired ratio. This design can be used in a proportioner feedblock section 106 of the composite feedblock 104, which connects to a subsequent mixer feedblock section 108. Moreover, the flow of the polymers could be controlled by variable channel size or with a modified, tunable metal plate that can move to partially block the feeding channels.

Referring to FIGS. 2 and 15, the internal geometry or surface of the proportioner feedblock section 106 or mixer feedblock section 108 in the composite feedblock 104 can be modified to improve mixing of the polymer components. Added tortuosity 156 can be used to promote mixing in the X, Y and Z direction. An example of such modification can include, for example, serrated patterns inside the channels. The channel shapes can change to circular, square, oval or other shapes.

Referring to FIGS. 2 and 15, an optional Section C (which may otherwise referred to herein as a combiner feedblock section 110) may be included in the system 100 to combine all the channels together to create a material sheet, film or other profile with varying material combinations. Optionally, section B or Section C may feed into a conventional polymer die used for profile, sheet or film extrusion to create polymer composite structure, which can be subsequently used for further processing. In accordance with the example of FIG. 23, the channels can combine to create a final material structure profile with (10:90)/(25:75)/(50:50)/(75:25)/(90:10) composition.

Referring to FIGS. 5, 16 and 17, the proportioner feedblack section 106 may feature triangular or circular channels, which when connected with next mixer feedblock section 108, may split the polymer melt into different channels with same or different dimensions. As the two polymer streams are unevenly split, each stream feeding into next feedblock can create a different polymer mixture, which when combined as output may create a gradient refractive index structure. Alternatively or in addition, the mixer feedblock section 108 may have similar or variable dimensions inlet channels to modify the output gradient profile.

Particular preferred implementations of the system 100 enable a manufacturing method to produce gradient refractive index optical materials using a composite feedblock technology with plurality of materials with at least two or more polymers. Using the composite feedblock with plurality of conduits for polymer melt to flow, combine and mix results in the creation of gradient optics sheet materials that can be used to fabricate gradient index optical materials.

The gradient materials created using two or more polymers feeding into composite feedblock may contain a mixture of polymers with or without additional additive materials. For example, the GRIN sheet produced may demonstrate transmission to various wavelengths of lights in 200 nm to 2 μm wavelength range. Based on the material choice, the optical transmission can be more than 70% in 380 to 900 nm wavelength range.

Employing particular implementations of the system 100 and associated methods disclosed herein, the resulting manufactured gradient materials 102 with polymers, mixtures of polymers and/or additives can be used for broader wavelength applications from visible to long-wave infrared wavelengths.

Preferred embodiments of the system 100 and associated methods disclosed herein relate to manufacturing methods for gradient refractive index optics (GRIN) materials and GRIN optical elements fabricated from optical material composites. Each optical composite embodiment may comprise streams two or more polymer materials, completely or partially miscible or immiscible, combined in different ratios in a feedblock and combined to create a gradient index structure 102.

The relative ratio of the two or more materials in two or more consecutive channels may be controlled to create a mixture of polymers. The two or more polymers can be partially or fully miscible or immiscible. Examples of combining polymer melt streams are shown in FIGS. 17 and 23-31. The process shows a profile with graded refractive index materials.

In the example shown in FIG. 23, a two-polymer stream system shows different channel dimensions which combine to create a linear gradient material 102 comprising a first polymer material 118a and a second polymer material 118b. The first and second polymer material may optionally comprise additional polymers to improve product performance of the resulting gradient material 102. An example would be a first polymer material 118a being blended with a Polymer C or additives, and second polymer material 118b mixed with a Polymer D or additives.

The example in FIG. 24 illustrates a case in which additional channels are provided on the top and bottom to cap the gradient structure. These additional channels may be referred to as non-proportioning channels (186a, 186b). The non-proportioning channels would likely not require corresponding mixing channels in the mixer feedblock section 108, since they are not feeding two or more unmixed polymers into the mixer feedblock section 108.

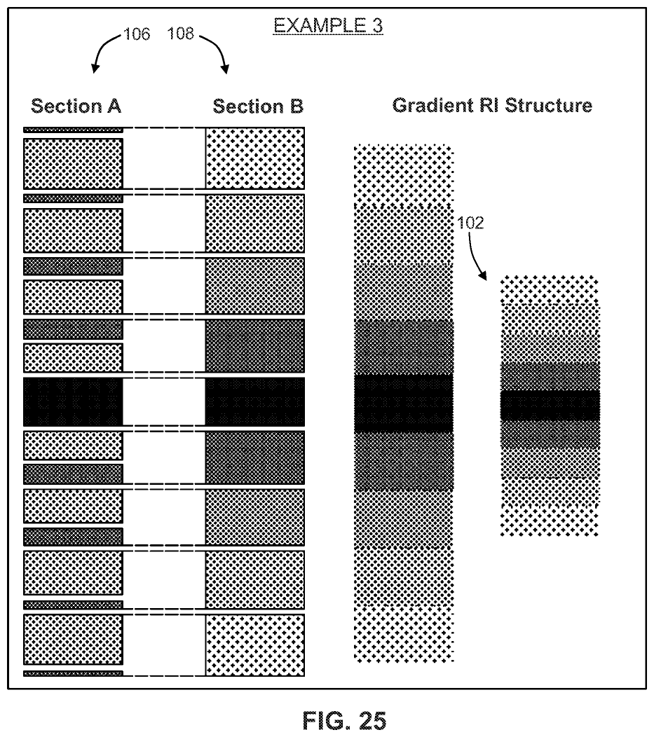

FIG. 25 illustrates the ability for the system 100 to generate a gradient structure 102 with a curved gradient index by way of varying the respective channel dimensions.

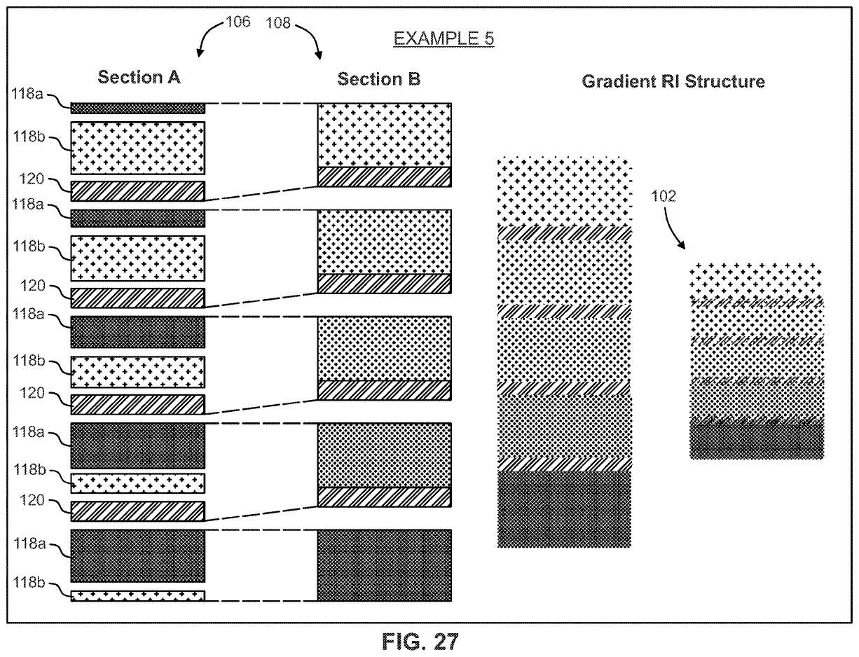

FIGS. 26 and 27 illustrate the addition of an auxiliary polymer material 120, such as a third polymer stream containing one or more polymers, potentially with one or more fillers or additives. The third stream 120 may be compatible with existing polymers or can act as an adhesive layer or a performance enhancer.

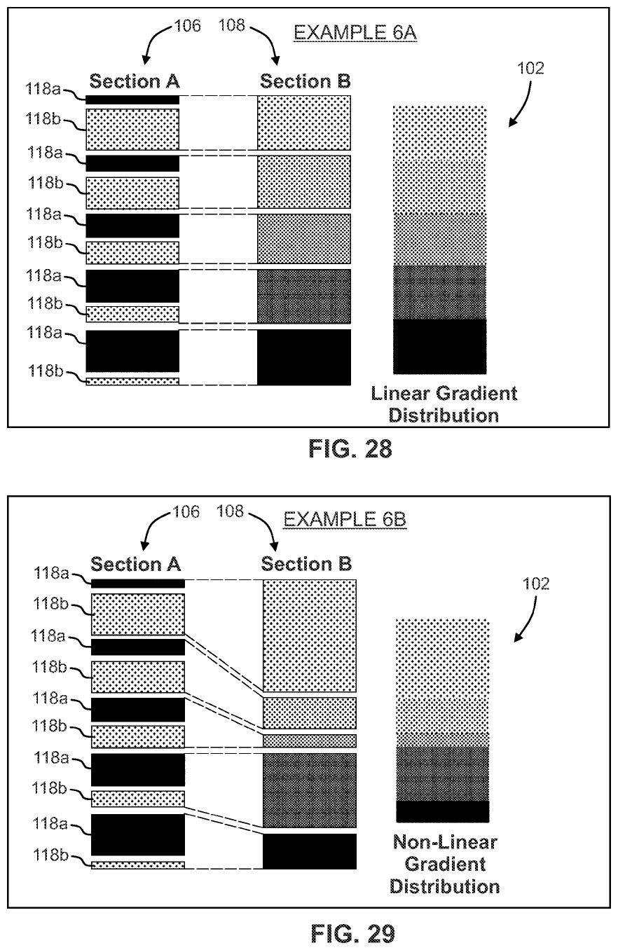

FIGS. 28 and 29 comparatively illustrate linear and non-linear gradient structures 102 created by way of relative variations in channel dimensions within the feedblock sections.

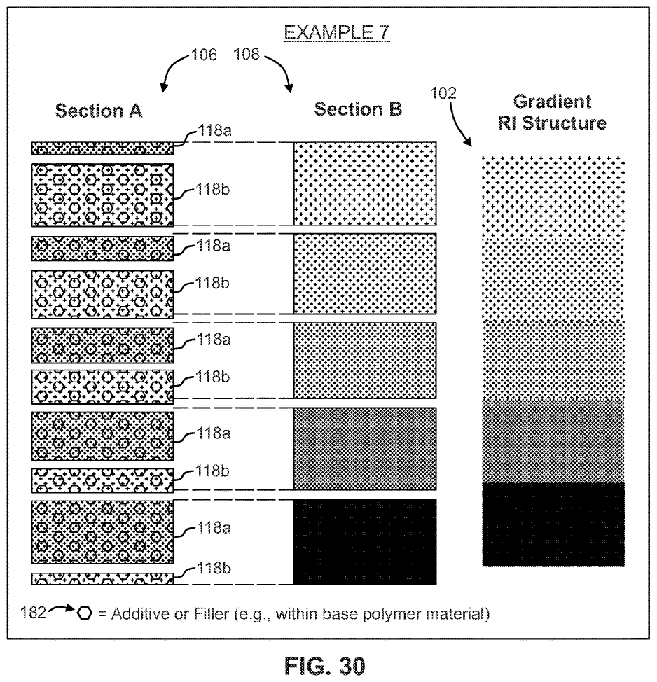

FIG. 30 illustrates the use of one or more additional components (e.g., additives, fillers or polymers) 182 that can be added to starting material such as the first and/or second polymer materials (118a, 118b).

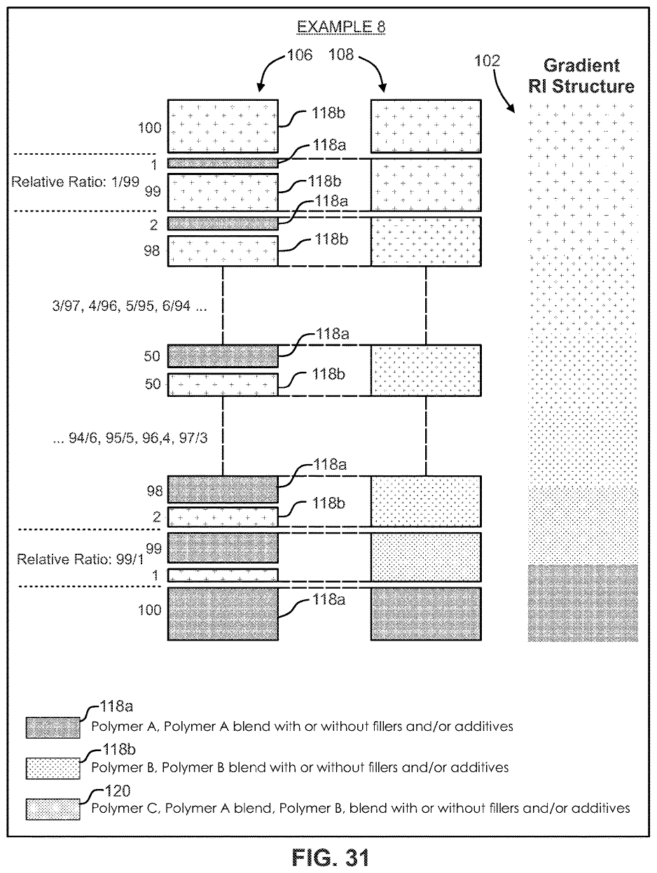

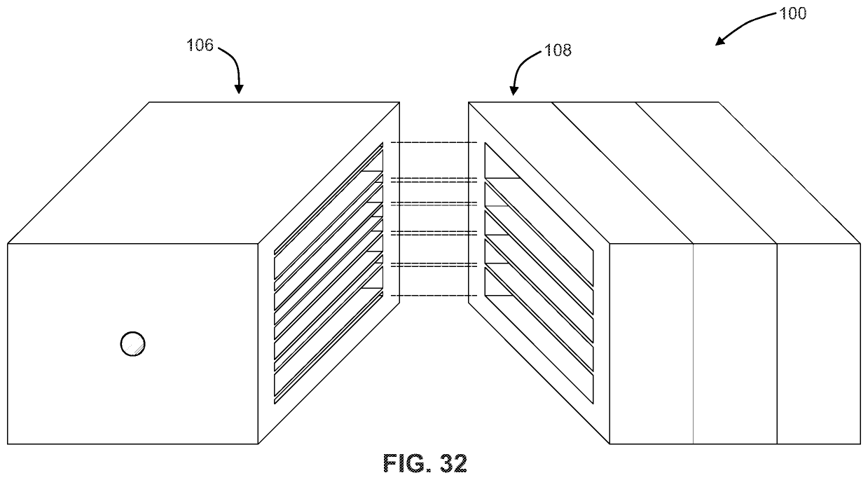

FIG. 31 illustrates a variation of consecutive proportioning and mixing channels with 1% variation with two outside layers without any mixing. Such a feedblock design may have, for example, 200 starting channels in section A and would feed into 101 channels in section B and then combine to create a resulting gradient structure 102.

In certain preferred implementations of the system 100 and associated methods disclosed herein, the manufactured gradient material structure 102 may take the form of a sheet structure that can further be molded, shaped and cut into gradient optics elements, lenses and products.

The polymer materials (components) discussed herein (e.g., 118a, 118b, 120) may preferably be selected from the group consisting of a polyethylene naphthalate, an isomer thereof, a polyalkylene terephthalate, a polyimide, a polyetherimide, a styrenic polymer, a polycarbonate, a poly(methyl meth)acrylate derivatives, a cellulose derivative, a polyalkylene polymer, a fluorinated polymer, a chlorinated polymer, a polysulfone, a polyethersulfone, polyacrylonitrile, a polyamide, polyvinylacetate, a polyether-amide, a styrene-acrylonitrile copolymer, a styrene-ethylene copolymer, poly(ethylene-1,4-cyclohexylenedimethylene terephthalate), polyvinylidene difluoride, an acrylic rubber, isoprene, isobutylene-isoprene, butadiene rubber, butadiene-styrene-vinyl pyridine, butyl rubber, polyethylene, chloroprene, epichlorohydrin rubber, ethylene-propylene, ethylene-propylene-diene, nitrile-butadiene, polyisoprene, silicon rubber, styrene-butadiene, urethane rubber, and polyoxyethylene, polyoxypropylene, and tetrafluoroethylene hexafluoropropylene vinylidene (THV), aromatic polyesters, aromatic polyamides, and ethylene norbornene copolymers. The polymer components can be miscible, immiscible or partially miscible polymeric materials. Typical examples of some or all of these polymers are referenced in conventional published literature. The polymer materials (e.g., 118a, 118b, 120) may be selected or configured to contain additives, inorganic or organic materials with ability to affect material properties such as refractive index.

Below are example methodologies which a reader having ordinary skill in the relevant art will readily be able to implement with the benefit of the present disclosure:

A feedblock technology comprised of multiple channels to fabricate a composite sheet, the technology comprising, individually or in some combination, one or more of any of the following aspects:
a. Wherein the feedblock may contain one composite or plurality of sections with different functionalities to promote mixing and combining polymer streams;
b. Wherein the feedblock construction is comprised of plurality of channels or conduits in one or more sections;
c. Wherein the feedblock construction is comprised of replaceable channel inserts to modify gradient mixing to create designed gradient structures;
d. Wherein the consecutive relative channel size distribution within a feedblock can vary between 0.1 to 100% variation;
e. Wherein a minimum of two polymer melt streams (A, B) feed into the feedblock into alternative or consecutive channels, while mixing in the subsequent section as the channels combine;
f. Wherein the number of channels in each section can vary from 2 to 4000, typically ranged from 2 to 250;
g. Wherein a minimum two consecutive channels containing same or different polymers combine into same or next section of the feedblock or into another feedblock, which may contain additional features to improve the mixing efficiency of the component materials;
h. Wherein the number of channels in section B of the feedblock are typically less than the number of channels;
i. Wherein the next section or a new feedblock will carry mixed polymer streams into another feedblock or a die to produce a profile or a sheet which may have a gradient mixing profile defined by the feedblock design; or
j. Wherein the section length can control the mixing of the component polymers and diffusion across polymer streams when combined in section B or C.

A gradient refractive index composite manufacturing process comprising, individually or in some combination, one or more of any of the following aspects:
a. Wherein the composite sheet is comprised of a plurality of polymers or blends of polymers which may contain other additives;
b. Where the polymer mixing occurs inside the feedblock design to create a sheet or a profile product with gradient index extrudate;
c. Wherein each composite sheet is comprised of combined polymer components of at least two polymer materials;
d. Wherein a minimum of two polymers or blends of polymers are extruder through feedblock assembly creating mixture of two component polymers with variable refractive index components creating a gradient index optics extrudate;
e. The extrudate structure has a variable transmission for variable light wavelengths;
f. The component materials are miscible, partially miscible or immiscible polymer materials and may contain other additives;
g. The GRIN extrudate may contain two to hundreds of sections with variable refractive index; or
h. Wherein the GRIN extrudate product can be shaped and cut into GRIN products or optical elements.

The following listing matches certain terminology used within this disclosure with corresponding reference numbers used in the non-limiting examples illustrated in the several figures.
100 system (i.e., gradient material structure manufacturing system)
102 gradient material structure
104 composite feedblock
106 proportioner feedblock section (e.g., section A)
108 mixer feedblock section (e.g., section B)
110 combiner feedblock section
112 polymer die
114a first flow inlet (of proportioning feedblock)
114b second flow inlet (of proportioning feedblock)
116a first melt extruder
116b second melt extruder
118a first polymer material
118b second polymer material
120 auxiliary polymer material (e.g., third polymer material, adhesive material, enhancement material)
122a first proportioner channel
122b second proportioner channel
122c third proportioner channel
122d fourth proportioner channel
124 proportioner outlet
126a first polymer conduit
126b second polymer conduit
128 auxiliary channel
130 first cross-sectional geometry
132 first cross-sectional area
134 second cross-sectional geometry
136 second cross-sectional area
138a first mixer channel (of mix feedblock section)
138b second mixer channel
138c third mixer channel
138d fourth mixer channel
140 mix inlet
142 mix outlet
144 first width (of first cross-sectional, geometry)
146 first height (of first cross-sectional, geometry)
148 second width (of second cross-sectional, geometry)
150 second height (of second cross-sectional, geometry)
152 combiner channel
154 die channel
156 tortuosity of surface (e.g., in mixing channel)
158 polymer transfer flow direction
160 mix channel distribution direction
162 insert element (e.g., removably mounted within proportioner feedblock section)
164 auxiliary flow inlet
166 combiner inlet
168 mixed polymer
170 auxiliary extruder (i.e., third extruder)
172 polymer transfer interface
174 mix transfer interface
176 combiner outlet
178 mix channel divider
180 proportioner feedblock divider
182 additive or filler
184 proportioner insert sheath
186a first non-proportioning channel
186b second non-proportioning channel

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A system for manufacturing a gradient material structure, the system comprising:
a proportioner feedblock section having a first flow inlet for receiving a first polymer material in melted form, a second flow inlet for receiving a second polymer material in melted form, and one or more proportioner channels, each said proportioner channel having
(a) a proportioner outlet;
(b) a first polymer conduit in fluid communication between the first flow inlet and the proportioner outlet; and
(c) a second polymer conduit in fluid communication between the second flow inlet and the proportioner outlet; and
a mixer feedblock section having a plurality of mixer channels extending therethrough, each of the mixer channels being in fluid communication with the proportioner outlet of a corresponding said proportioner channel;
wherein
(a) each mixer channel is configured to simultaneously receive from the corresponding proportioner channel the first polymer material at a first volume flow rate and the second polymer material at a second volume flow rate, the ratio between the first and second volume flow rates defining at least in part a polymer transfer ratio for the respective mixer channel, and
(b) the polymer transfer ratios differ between two or more of the mixer channels.

2. The system as defined in claim 1, wherein some or all of the mixer channels are in fluid communication with the proportioner outlet of the same proportioner channel.

3. The system as defined in claim 1, wherein
(a) each of the mixer channels has a mix inlet and a mix outlet, and
(b) for a set of the mixer channels,
(i) the mix inlet of each mixer channel is in alignment in fluid communication with a different portion of the same proportioner outlet, and
(ii) the polymer transfer ratios vary between the mixer channels depending upon the alignment of the respective mix inlet.

4. The system as defined in claim 1, wherein some or all of the mixer channels are in fluid communication with proportioner outlets of separate proportioner channels.

5. The system as defined in claim 1, wherein for each proportioner channel,
(a) the first polymer conduit has, at the proportioner outlet, a first cross-sectional geometry with a first cross-sectional area,
(b) the second polymer conduit has, at the proportioner outlet, a second cross-sectional geometry with a second cross-sectional area, and
(c) the polymer transfer ratio for each mixer channel in fluid communication with the proportioner channel is based at least in part on the ratio of the first and second cross-sectional areas.

6. The system as defined in claim 5, wherein for each proportioner channel,
(a) the first cross-sectional geometry has a first width and a first height,
(b) the second cross-sectional geometry has a second width and a second height, and
(c) the polymer transfer ratio for each mixer channel in fluid communication with the proportioner channel is based at least in part on the ratio of the first and second heights.

7. The system as defined in claim 6, wherein the first and second widths are identical to one another.

8. The system as defined in claim 5, wherein the polymer transfer ratios of the mixer channels vary between 0.1 to 100%.

9. The system as defined in claim 1, wherein the system comprises a combiner feedblock section having at least one combiner channel extending therethrough, each combiner channel having a combiner inlet in fluid communication with two or more of the mixer channels.

10. The system as defined in claim 9, wherein the combiner feedblock section has a single said combiner channel, and the combiner inlet is in fluid communication with all of the mixer channels.

11. The system as defined in claim 1, wherein the system comprises a polymer die having a die channel extending therethrough, the die channel being in fluid communication with each of the mixer channels.

12. The system as defined in claim 1, wherein at least one of the mixer channels includes surface tortuosity to promote mixing of polymer materials moving therethrough.

13. The system as defined in claim 1, wherein the first polymer material has a first refractive index, the second polymer material has a second refractive index, and the first and second refractive indexes are different from one another.

14. The system as defined in claim 1, wherein the mixer channels are linearly distributed in a mix channel distribution direction.

15. The system as defined in claim 1, wherein the feedblock sections are separably fastenable to one another.

16. The system as defined in claim 1, wherein each said proportioner channel is housed within a respective insert element removably mounted within the remainder of the proportioner feedblock section.

17. The system as defined in claim 1, wherein multiple proportioner channels are defined in a single insert element removably mounted within the remainder of the proportioner feedblock section.

18. The system as defined in claim 1, wherein
(a) the proportioner section has an auxiliary flow inlet for receiving an auxiliary polymer material in melted form,
(b) at least one of the one or more proportioner channels respectively has an auxiliary polymer conduit in fluid communication between the auxiliary flow inlet and the proportioner outlet end, and
(c) at least one mixer channel is configured to receive from a corresponding proportioner channel the auxiliary polymer material at an auxiliary volume flow rate, the ratio between the first, second and auxiliary volume flow rates defining at least in part a polymer transfer ratio for the respective mixer channel.

19. The system as defined in claim 1, wherein the mixer feedblock includes at least 50 mixer channels.

20. The system as defined in claim 19, wherein the proportioner feedblock includes at least 50 proportioner channels.

21. The system as defined in claim 1, wherein the at least one of the polymer materials comprises chemical constituents able to affect refractive index of the polymer material.

22. The system as defined in claim 1, wherein the gradient material structure is a composite sheet comprised of a plurality of polymers, polymer blends, or blends of polymers which contain additives.

23. The system as defined in claim 1, wherein the gradient material structure is a sheet or profile product comprised of gradient extrudate extruded from the system.

24. The system as defined in claim 23, wherein the gradient material structure is a gradient refractive index (GRIN) optics element.
